(19) United States
(12) Patent Application Publication
(10) Pub. No.: US 2020/0082014 A1
(43) Pub. Date: Mar. 12, 2020

(54) SYSTEMS AND METHODS FOR REMOTE OBJECT CLASSIFICATION

(71) Applicant: Veoneer US, Inc., Southfield, MI (US)

(72) Inventors: Christopher Unverdorben, Freising (DE); Robert Schneider, Munich (DE); Hendrik Bottcher, Neufahrn b. Freising (DE)

(21) Appl. No.: 16/129,748

(22) Filed: Sep. 12, 2018

(51) Int. Cl. G06F 17/30; G06N 99/00; G01S 7/41

(52) U.S. Cl. CPC G06F 17/30598; G01S 7/41; G06N 99/005

(57) ABSTRACT

Methods and systems for classification of remote objects from within a host vehicle. In some implementations, the method may comprise using a RADAR sensor within a host vehicle to obtain data of a first property of a remote object. The data may then be filtered to obtain a subset of data, such as a predetermined number of data points comprising extrema data points in the data set. A statistical analysis may be performed using the subset of data and the remote object may be classified as one of a plurality of distinct object types using the results of the statistical analysis.

### SUMMARY

Systems and methods relating to classification of objects using a remote detection and/or tracking system in a host vehicle are disclosed herein. Detectable properties of objects being detected and/or tracked by such host vehicle detection and/or tracking systems, such as the measured/perceived area of the objects, may fluctuate during tracking as, for example, the objects change in distance from the host vehicle. These fluctuations may make it difficult to accurately classify the remote objects. For example, useful information may not always be retained and/or used later to improve object classification.

The present inventors have therefore determined that it would be desirable to provide systems and methods that overcome one or more of the foregoing limitations and/or other limitations of the prior art. Thus, in some embodiments, the inventive concepts disclosed herein may be used to improve upon object classification by reducing such measured fluctuations. This may be accomplished, for example, by filtering data into subsets, such as by filtering the sensed data points into a subset comprising a predetermined number of data points comprising the maximum or minimum data points in the set. A statistical analysis may then be performed on the filtered data, which may result in a statistical parameter. This parameter may then be used to improve upon classification of remote objects using the sensed data by, for example, using the statistical parameter as a new feature in a machine-learning system.

In a more particular example of a method for classification of RADAR detected objects from within a host vehicle, the method may comprise using a RADAR sensor within a host vehicle to obtain a plurality of data/data points of a first property of a remote object. The plurality of data/data points may be filtered to obtain a subset of the plurality of data points. In preferred implementations, the subset of the plurality of data points may comprise a predetermined number of data points comprising extrema data points in the plurality of data points. A statistical analysis may then be performed using the subset of the plurality of data points. The remote object may be classified as one of a plurality of distinct object types using the results of the statistical analysis of the plurality of data points.

In some implementations, a feature, such as a feature in a machine learning algorithm, model, and/or system, may be derived from the statistical analysis. In some such implementations, the feature may comprise at least one of a mean and a median of the subset of the plurality of data points. The subset of the plurality of data points may comprise the predetermined number of data points within the subset having the highest value.

The first property of the remote object may comprise any characteristic, property, and/or parameter of a remote object that can be remotely detected/sensed, such as a perceived area, a perceived dimension, a velocity/speed, or a distance of the remote object.

In another example of a method for classification of remotely detected objects from within a host vehicle, the method may comprise using a first object sensor within a host vehicle, such as a RADAR sensor, to obtain a plurality of data points of a first property of a remote object. The plurality of data points may be filtered to obtain a subset of the plurality of data points. The subset of data/data points may then be used in a statistical analysis using the subset of the plurality of data points. The results of the statistical analysis may then be used to classify the remote object.

In some implementations, the step of filtering the plurality of data points may comprise filtering at least one of a grouping of the highest data point values in the plurality of data points and a grouping of the lowest data point values in the plurality of data points.

In some implementations, each of the plurality of data points may comprise a measurement indicative of a perceived size of the remote object, such as a perceived area of the remote object.

In some implementations, the step of filtering the plurality of data points may comprise filtering a predetermined number of data points comprising extrema data points in the plurality of data points. In some such implementations, the step of filtering the plurality of data points may comprise filtering a grouping of the highest data point values in the plurality of data points.

The step of performing a statistical analysis using the subset of the plurality of data points may comprise, for example, calculating at least one of a median and a mean of the subset of the plurality of data points.

In some implementations, the step of classifying the remote object using the results of the statistical analysis of the plurality of data points may comprise classifying the remote object as one of a plurality of distinct object types using the results of the statistical analysis of the plurality of data points. In some such implementations, the method may further comprise deriving a feature from the statistical analysis for a machine learning model.

In an example of a system for classification of remotely detected objects from within a host vehicle according to some embodiments, the system may comprise a first object sensor configured to receive a first set of sensed data of a remote object, such as a perceived area, a perceived dimension, a speed, and a distance of the remote object; a filtering module configured to filter the first set of sensed data to obtain a second set of sensed data comprising a subset of the first set of sensed data; a statistical analysis module configured to perform a statistical analysis on the second set of sensed data; and an object classification module configured to use data from the statistical analysis module to classify the remote object.

Some embodiments may further comprise a machine learning module, which may be configured to use data from the statistical analysis module as a feature in a machine learning algorithm.

In some embodiments, the filtering module may be configured to maintain a running account of a predetermined number of data points within the subset having the highest value. Thus, the statistical analysis module may be configured to determine at least one of a mean and a median of the predetermined number of data points within the subset having the highest value.

The object classification module may be configured to use the at least one of a mean and a median of the predetermined number of data points to classify the remote object.

The features, structures, steps, or characteristics disclosed herein in connection with one embodiment may be combined in any suitable manner in one or more alternative embodiments.

### BRIEF DESCRIPTION OF THE DRAWINGS

Non-limiting and non-exhaustive embodiments of the disclosure are described, including various embodiments of the disclosure with reference to the figures, in which:

FIG. 1 is a graph of track histories of the perceived area of objects being tracked by a remote object tracking system;

FIG. 2 is a graph of track histories of a derived quantity of the mean of the highest N values of a perceived area of objects being tracked by a remote object tracking system according to some embodiments;

FIG. 3 is a graph plotting the perceived area of objects being tracked by a remote object tracking system during a particular cycle according to some embodiments vs. the results of a compiled, statistical analysis of a plurality of previous data points of the perceived area;

FIG. 4 illustrates a system for classification of remotely detected objects from within a host vehicle according to some embodiments; and

FIG. 5 is a flow chart depicting an example of a method for classification of remotely detected objects from within a host vehicle according to some implementations.

### DETAILED DESCRIPTION

A detailed description of apparatus, systems, and methods consistent with various embodiments of the present disclosure is provided below. While several embodiments are described, it should be understood that the disclosure is not limited to any of the specific embodiments disclosed, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

Apparatus, methods, and systems are disclosed herein relating to new methods and systems for classification of remotely-detected objects from within a host vehicle. In some embodiments, the inventive principles disclosed herein may be used to classify such objects using the results of a statistical analysis of a set of data and/or a plurality of data points to provide a new feature, parameter, and/or other input to an object classification module to improve the classification efficiency and/or accuracy. This analysis may, in some embodiments and implementations, be performed on predetermined subset of the data set/data points, such as a predetermined number of maximum or minimum values in the set.

The embodiments of the disclosure may be best understood by reference to the drawings, wherein like parts may be designated by like numerals. It will be readily understood that the components of the disclosed embodiments, as generally described and illustrated in the figures herein, could be arranged and designed in a wide variety of different configurations. Thus, the following detailed description of the embodiments of the apparatus and methods of the disclosure is not intended to limit the scope of the disclosure, as claimed, but is merely representative of possible embodiments of the disclosure. In addition, the steps of a method do not necessarily need to be executed in any specific order, or even sequentially, nor need the steps be executed only once, unless otherwise specified. Additional details regarding certain preferred embodiments and implementations will now be described in greater detail with reference to the accompanying drawings.

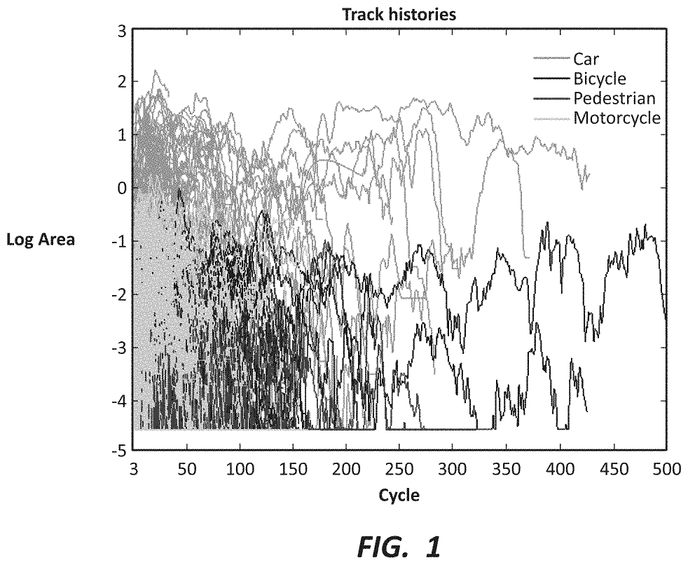

FIG. 1 is a graph of track histories of the perceived area of objects being tracked by a typical remote object tracking system. The graph of FIG. 1 plots cycles of a tracking history vs. the logarithm of the perceived and/or measured area of a variety of objects that might be identified and/or tracked by such a system. As indicated in this graph, the measured/perceived area of the objects may fluctuate during tracking. Similarly, other detectable properties of identified/tracked objects may fluctuate, making it difficult to accurately classify the objects and/or retain and use useful information that may otherwise be used to improve object classification. For example, with respect to a remotely-detected vehicle, the long side of the vehicle may be first detected/perceived, after which a shorter side may be perceived. Because the shorter side may correspond with a variety of other objects, this may make classification of the object more difficult.

As another example, because many bicycles and pedestrians may have the same width but different lengths, accurate classification of such distinct object types may be difficult due to the differences in perceived dimensions from different perspectives, particularly when using RADAR sensors.

As yet another example, the perceived velocity/speed of a vehicle may change dramatically over time, and some of the velocity/speed measurements may resemble other objects during certain cycles. Again, this may make object classification difficult. Similarly, objects that are far away may result in fluctuations since the true properties (size, area, speed, or otherwise) may be difficult to measure at great distances.

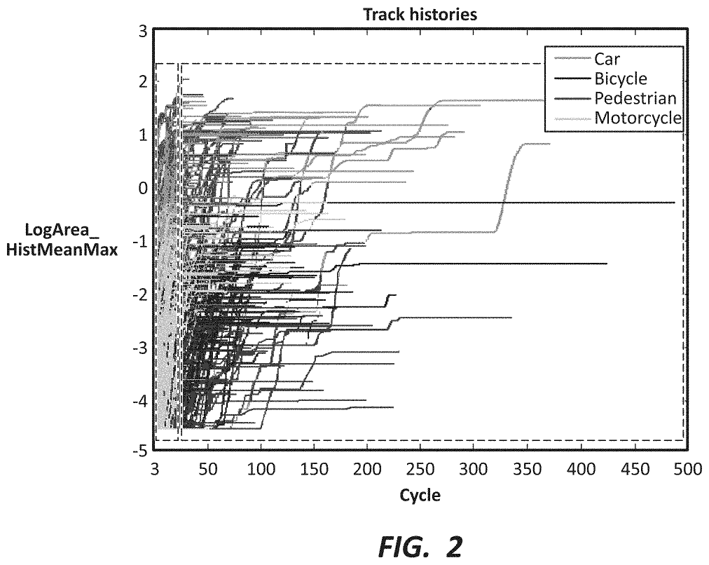

FIG. 2 is a graph of track histories of the perceived area of objects being tracked by a remote object tracking system incorporating one or more of the inventive features/aspects disclosed herein. As shown in this graph, each of the various objects indicated in FIG. 1 (car, bicycle, pedestrian, motorcycle), by use of the inventive principles presented herein, which are discussed in greater detail below, provides an improvement on the ability to accurately classify remotely-detected and/or tracked objects.

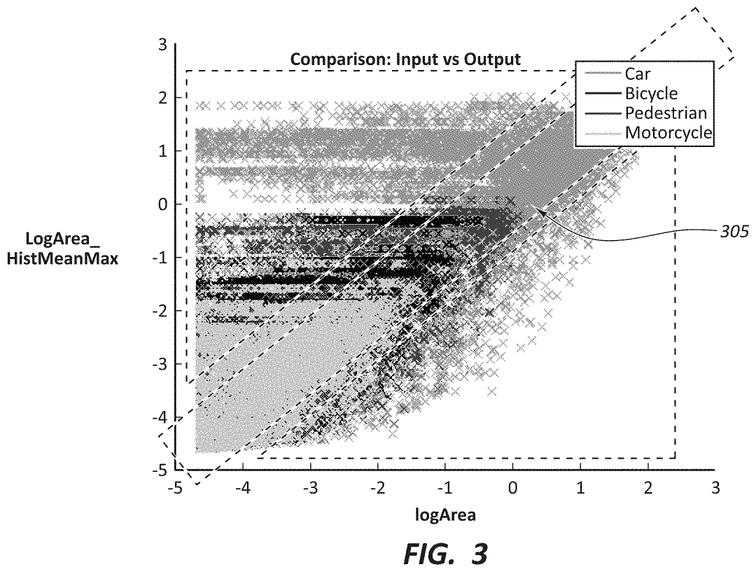

FIG. 3 is a graph plotting the perceived area of objects being tracked by a remote object tracking system during a particular cycle according to some embodiments. This graph plots the logarithm of the perceived area on the x axis and the compiled, statistical analysis of the logarithm of the perceived area of a plurality of data points on the y axis. More particularly, the y axis is the mean of a plurality of maximum data points. As described in greater detail below, some embodiments may be configured to filter a plurality of data points, such as the plurality of perceived area data points of FIG. 3, to obtain a subset of the plurality of data points. In preferred embodiments, the subset of the plurality of data points may comprise a predetermined number of data points comprising extrema data points in the plurality of data points. Thus, as previously mentioned, the plot of FIG. 3 indicates that a grouping of maximum perceived area data points was filtered. A statistical analysis may then be performed using the subset of the plurality of data points. Thus, the plot of FIG. 3 indicates that the mean of the plurality of maximum data points was used. Remote objects may then be more accurately and/or readily classified as one of a plurality of distinct object types using the results of the statistical analysis of the plurality of data points.

FIG. 3 also depicts a set of cycles/data points lying on or near a diagonal, as indicated at 305. Without using the filtering and/or statistical analysis referenced herein, each of the cycle data points would lie on this diagonal region. However, by applying the statistical analyses disclosed herein, many data points moved from this diagonal up into the upper left triangular region, thus allowing to distinguish between different object types with the help of this new feature, which would not have been possible without it. Hence, this or similar other additional features or the results of the analyses may otherwise be used to improve the ability of a remote detection and/or classification system to classify different objects according to object type, such as pedestrians, cars, bicycles, motorcycles, etc.

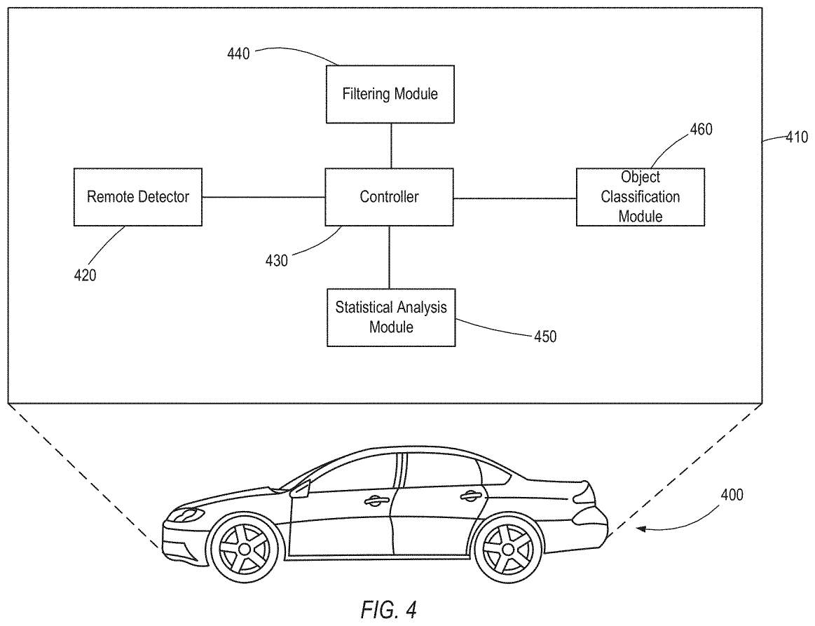

FIG. 4 illustrates a host vehicle 400 comprising a system 410 for classification of remotely detected objects from within the host vehicle according to some embodiments. As shown in this figure, system 410 may comprise one or more remote detectors 420, such as RADAR sensors/modules, LIDAR sensors/modules, cameras, etc. Remote detector(s) 420 may be configured to receive sensed data from remote objects, such as other vehicles, pedestrians, bicycles, and/or stationary objects.

A controller 430 may be provided in order to allow for processing of data from remote detector(s) 420 and/or any of the various modules of system 410 described below. As used herein, the term controller refers to a hardware device that includes a processor and preferably also includes a memory element. The memory may be configured to store one or more of the modules referred to herein and the controller 430 and/or processor may be configured to execute the modules to perform one or more processes described herein.

A filtering module 440 may be configured to filter sensed data from remote detector(s) 420 to obtain a second set of sensed data made up of a subset of a first set of sensed data from the remote detector(s) 420. In preferred embodiments, filtering module 440 may be configured to filter a set of extrema data, such as a predetermined number of maximum or minimum data points. For example, in some embodiments, filtering module 440 may be configured to use/filter only the n highest or lowest values of a particular sensed property of remotely-detected objects, such as perceived area, another perceived dimension, speed/velocity, distance, etc. This filtered data can then be reused from the track history to improve object classification, as described in greater detail below.

System 400 may further comprise a statistical analysis module 450, which may be configured to perform a statistical analysis on the second/filtered set of sensed data. Examples of such statistical analyses include taking the mean, median, and/or variance of the filtered data. For example, if perceived area is used as the measured property and the filtering step filters the ten maximum data points of this property, module 450 may be configured to take the mean of these maximum data points.

Object classification module 460 may then be configured to use data from the statistical analysis module 450 to classify the remote object. For example, object classification module 460 may use the mean of the subset of maximum data points, or another statistical parameter of any suitable filtered set of data, as a separate “feature” in a machine learning algorithm or system. In some embodiments, the parameter and/or feature from the statistical analysis may be used alone to classify the object. Alternatively, other parameters and/or features may be used in conjunction with the parameter/feature derived from the statistical analysis to classify objects.

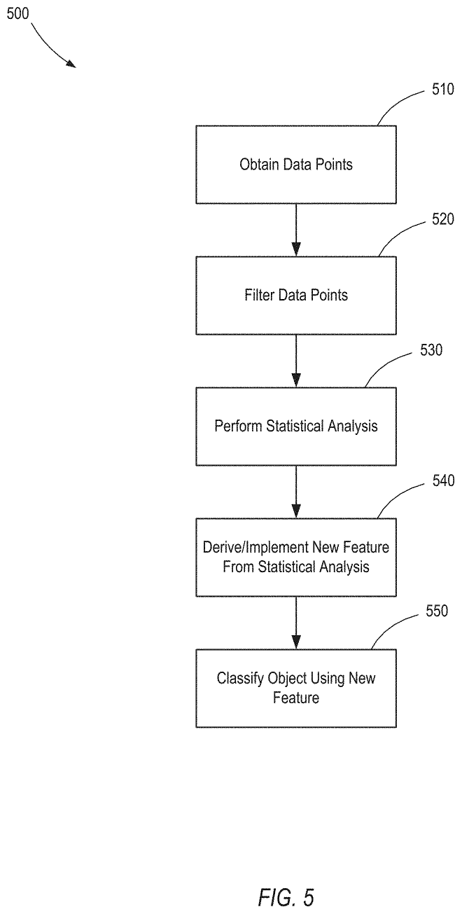

FIG. 5 is a flow chart depicting an example of a method 500 for classification of remotely detected objects from within a host vehicle according to some implementations. Method 500 may begin at 510 by gathering data. For example, RADAR sensors or other remote detectors/sensors/modules may be used to sense/detect characteristics/parameters of a remote object, such as length, width, area, speed, velocity, distance, etc.

Once a sufficient number of data points and/or amount of data has been obtained, the data may be filtered at 520. For example, in some implementations, step 520 may comprise filtering at least one of a grouping of the highest data point values in the plurality of data points and a grouping of the lowest data point values in the plurality of data points. In some implementations, the grouping of highest data point values may comprise a predetermined number, such as n=10 for example. Thus, in some implementations, step 520 may not begin until a sufficient number of data points has been gathered and/or cycles have been completed. However, it is contemplated that, in other implementations, step 520 may begin immediately upon obtaining a single data point.

Method 500 may then proceed to step 530 at which point a statistical analysis may be performed using the filtered data. For example, in some implementations, step 530 may comprise calculating the mean, median, or mode of the filtered data/predetermined number of data points.

In some implementations, method 500 may then proceed to step 540 at which point a new feature may be derived, used, and/or implemented using the results of the statistical analysis of step 530. For example, in some implementations utilizing machine learning systems/tools, step 540 may comprise the creation and/or utilization of a new feature that comprises the mean, median, mode, or another suitable statistical parameter of the filtered data. This feature may then be used to train a tracking and/or classification system, such as system 410, to improve future tracking, or may otherwise by used to classify the object(s) or improve upon an existing methodology for classification of the object(s), at 550.

As used herein, a software module or component may include any type of computer instruction or computer executable code located within a memory device and/or m-readable storage medium. A software module may, for instance, comprise one or more physical or logical blocks of computer instructions, which may be organized as a routine, program, object, component, data structure, etc., that perform one or more tasks or implements particular abstract data types.

In certain embodiments, a particular software module may comprise disparate instructions stored in different locations of a memory device, which together implement the described functionality of the module. Indeed, a module may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

Furthermore, embodiments and implementations of the inventions disclosed herein may include various steps, which may be embodied in machine-executable instructions to be executed by a general-purpose or special-purpose computer (or other electronic device). Alternatively, the steps may be performed by hardware components that include specific logic for performing the steps, or by a combination of hardware, software, and/or firmware.

Embodiments and/or implementations may also be provided as a computer program product including a machine-readable storage medium having stored instructions thereon that may be used to program a computer (or other electronic device) to perform processes described herein. The machine-readable storage medium may include, but is not limited to: hard drives, floppy diskettes, optical disks, CD-ROMs, DVD-ROMs, ROMs, RAMs, EPROMs, EEPROMs, magnetic or optical cards, solid-state memory devices, or other types of medium/machine-readable medium suitable for storing electronic instructions. Memory and/or datastores may also be provided, which may comprise, in some cases, non-transitory machine-readable storage media containing executable program instructions configured for execution by a processor, controller/control unit, or the like.

The foregoing specification has been described with reference to various embodiments and implementations. However, one of ordinary skill in the art will appreciate that various modifications and changes can be made without departing from the scope of the present disclosure. For example, various operational steps, as well as components for carrying out operational steps, may be implemented in various ways depending upon the particular application or in consideration of any number of cost functions associated with the operation of the system. Accordingly, any one or more of the steps may be deleted, modified, or combined with other steps. Further, this disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced, are not to be construed as a critical, a required, or an essential feature or element.

Those having skill in the art will appreciate that many changes may be made to the details of the above-described embodiments without departing from the underlying principles of the invention. The scope of the present inventions should, therefore, be determined only by the following claims.

1. A method for classification of RADAR detected objects from within a host vehicle, the method comprising the steps of:
using a RADAR sensor within a host vehicle to obtain a plurality of data points of a first property of a remote object;
filtering the plurality of data points to obtain a subset of the plurality of data points, wherein the subset of the plurality of data points comprises a predetermined number of data points comprising extrema data points in the plurality of data points;
performing a statistical analysis using the subset of the plurality of data points; and
classifying the remote object as one of a plurality of distinct object types using the results of the statistical analysis of the plurality of data points.

2. The method of claim 1, further comprising deriving a feature from the statistical analysis for a machine learning model.

3. The method of claim 2, wherein the feature comprises at least one of a mean and a median of the subset of the plurality of data points.

4. The method of claim 3, wherein the subset of the plurality of data points comprises the predetermined number of data points within the subset having the highest value.

5. The method of claim 4, wherein the first property of the remote object comprises at least one of a perceived area, a perceived dimension, a speed, and a distance of the remote object.

6. A method for classification of remotely detected objects from within a host vehicle, the method comprising the steps of:
using a first object sensor within a host vehicle to obtain a plurality of data points of a first property of a remote object;
filtering the plurality of data points to obtain a subset of the plurality of data points;
performing a statistical analysis using the subset of the plurality of data points; and
classifying the remote object using the results of the statistical analysis of the plurality of data points.

7. The method of claim 6, wherein the step of filtering the plurality of data points comprises filtering at least one of a grouping of the highest data point values in the plurality of data points and a grouping of the lowest data point values in the plurality of data points.

8. The method of claim 7, wherein each of the plurality of data points comprises a measurement indicative of a perceived size of the remote object.

9. The method of claim 8, wherein the first property comprises a perceived area of the remote object.

10. The method of claim 8, wherein the step of filtering the plurality of data points comprises filtering a predetermined number of data points comprising extrema data points in the plurality of data points.

11. The method of claim 10, wherein the step of filtering the plurality of data points comprises filtering a grouping of the highest data point values in the plurality of data points.

12. The method of claim 7, wherein the step of performing a statistical analysis using the subset of the plurality of data points comprises calculating at least one of a median and a mean of the subset of the plurality of data points.

13. The method of claim 6, wherein the first object sensor comprises a RADAR sensor.

14. The method of claim 6, wherein the step of classifying the remote object using the results of the statistical analysis of the plurality of data points comprises classifying the remote object as one of a plurality of distinct object types using the results of the statistical analysis of the plurality of data points, and wherein the method further comprises deriving a feature from the statistical analysis for a machine learning model.

15. A system for classification of remotely detected objects from within a host vehicle, comprising:
a first object sensor configured to receive a first set of sensed data of a remote object;
a filtering module configured to filter the first set of sensed data to obtain a second set of sensed data comprising a subset of the first set of sensed data;
a statistical analysis module configured to perform a statistical analysis on the second set of sensed data; and
an object classification module configured to use data from the statistical analysis module to classify the remote object.

16. The system of claim 15, further comprising a machine learning module, wherein the machine learning module is configured to use data from the statistical analysis module as a feature in a machine learning algorithm.

17. The system of claim 15, wherein the filtering module is configured to maintain a running account of a predetermined number of data points within the subset having the highest value.

18. The system of claim 17, wherein the statistical analysis module is configured to determine at least one of a mean and a median of the predetermined number of data points within the subset having the highest value.

19. The system of claim 18, wherein the object classification module is configured to use the at least one of a mean and a median of the predetermined number of data points to classify the remote object.

20. The system of claim 15, wherein the first set of sensed data comprises at least one of a perceived area, a perceived dimension, a speed, and a distance of the remote object.
